(19) United States
(12) Patent Application Publication
(10) Pub. No.: US 2026/0245909 A1
(43) Pub. Date: Aug. 20, 2026

(54) SELF-SUPPORTING ELECTRODE FILM AND METHOD OF MANUFACTURING THE SAME

(71) Applicant: TOYOTA JIDOSHA KABUSHIKI KAISHA, Toyota-shi (JP)

(72) Inventors: Tomohiro SATO, Toyota-shi (JP); Satoshi MORIYAMA, Nagoya-shi (JP)

(73) Assignee: TOYOTA JIDOSHA KABUSHIKI KAISHA, Toyota-shi (JP)

(21) Appl. No.: 19/410,430

(22) Filed: Dec. 5, 2025

(30) Foreign Application Priority Data
Feb. 14, 2025 (JP) 2025-022238

(51) Int. Cl. H01M 4/62; H01M 4/02; H01M 4/04; H01M 10/0525

(52) U.S. Cl. CPC H01M 4/623; H01M 4/0404; H01M 10/0525; H01M 2004/028

(57) ABSTRACT

The technology disclosed in the present specification relates to a self-supporting electrode film. The self-supporting electrode film includes positive electrode active material particles. In addition, the self-supporting electrode film includes a first polymer. Further, the self-supporting electrode film includes a second polymer. The first polymer has lithium-ion conductivity. The second polymer has a fibrillated state.

### CROSS-REFERENCE TO RELATED APPLICATION

This application claims priority to Japanese Patent Application No. 2025-022238 filed on Feb. 14, 2025. The disclosure of the above-identified application, including the specification, drawings, and claims, is incorporated by reference herein in its entirety.

### BACKGROUND

### 1. Technical Field

The technology disclosed in the present specification relates to a self-supporting electrode film and a method of manufacturing the same.

### 2. Description of Related Art

In recent years, self-supporting electrode films have come to be manufactured by a dry process. For example, a self-supporting electrode film containing polytetrafluoroethylene (PTFE) is known (Japanese Unexamined Patent Application Publication No. 2024-026272 (JP 2024-026272 A)). In JP 2024-026272 A, a composite binder combining polyvinylidene fluoride (PVDF), carboxymethyl cellulose (CMC), or the like is used to improve binding performance, while PTFE is used as a main binder. In this method, a mixture of active material, a conductive additive, and the composite binder is prepared, shear force is applied to fibrillate the PTFE, and then the mixture is pressed to produce a self-supporting electrode film.

### SUMMARY

In the method described in JP 2024-026272 A, PVDF or CMC is used to improve binding performance, while PTFE is used as a main binder. However, such polymers have low lithium-ion conductivity, which may result in a decrease in battery output.

The present specification provides a self-supporting electrode film and a method of manufacturing the same which can effectively improve output performance of a secondary battery.

The technology disclosed in the present specification is embodied in the following self-supporting electrode film and a method of manufacturing the same. A self-supporting electrode film according to a first aspect of the present disclosure includes:
positive electrode active material particles;
a conductive additive;
a first polymer having lithium-ion conductivity; and
a second polymer having a fibrillated state.

In the self-supporting electrode film according to the first aspect of the present disclosure, the first polymer may be polyethylene oxide having a degree of crystallinity of 10% or more and 50% or less.

In the self-supporting electrode film according to the first aspect of the present disclosure, a portion of a surface of each of the positive electrode active material particles may be coated with the first polymer.

In the self-supporting electrode film according to the first aspect of the present disclosure, the second polymer may contain polytetrafluoroethylene.

An electrode according to a second aspect of the present disclosure may include the self-supporting electrode film according to the first aspect.

A secondary battery according to a third aspect of the present disclosure may include the electrode according to the second aspect.

A method of manufacturing an electrode sheet for a self-supporting electrode film according to a fourth aspect of the present disclosure, the method includes:
preparing a first mixture by mixing positive electrode active material particles, a conductive additive, and a first polymer that has lithium-ion conductivity and does not fibrillate, with the first polymer in a flowable state;
preparing a second mixture by mixing the first mixture with a second polymer that is fibrillable, the second mixture containing the second polymer in a fibrillated state; and producing the electrode sheet by using the second mixture.

In the method of manufacturing the electrode sheet for the self-supporting electrode film according to the fourth aspect of the present disclosure, the first polymer may include polyethylene oxide having a degree of crystallinity of 10% or more and 50% or less.

A method of manufacturing an electrode including a self-supporting electrode film according to a fifth aspect of the present disclosure, the method includes: preparing a first mixture by mixing positive electrode active material particles containing an olivine-type positive electrode material provided with an electronically conductive material coating, a conductive additive, and a first polymer that does not fibrillate, with the first polymer in a flowable state;
preparing a second mixture by mixing the first mixture with a second polymer that is fibrillable, the second mixture containing the second polymer in a fibrillated state;
producing an electrode sheet for the self-supporting electrode film by using the second mixture; and
producing the electrode including the self-supporting electrode film by joining the electrode sheet to a current collector.

According to the self-supporting electrode film, since the first polymer has lithium-ion conductivity, the self-supporting electrode film can be constructed by fibrillation without reducing the lithium-ion conductivity of the positive electrode.

In addition, according to the method of manufacturing the electrode sheet, since the first polymer has lithium-ion conductivity, active material and the like can be kneaded without reducing the lithium-ion conductivity of the electrode film, and the bindability in the self-supporting electrode film by fibrillation can be improved.

During preparation of the first mixture, the first mixture is prepared with the first polymer in a flowable state. Therefore, the first polymer comes into intimate contact with the positive electrode active material particles, and the first polymer coats a portion of a surface of each of the positive electrode active material particles. Further, during preparation of the second mixture, the first polymer is constrained by and integrated with the second polymer in a fibrillated state, in a state in which the first polymer is well mixed with the positive electrode active material particles. Therefore, the electrode sheet and the self-supporting electrode film can be manufactured while lithium-ion conductivity is maintained.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing an example of a cell of a lithium-ion secondary battery;

FIG. 2 is a cross-sectional view schematically showing an example of a structure of a positive electrode disclosed in the present specification;

FIG. 3 is a diagram schematically showing an example of a form of existence of active material particles and the like in the electrode film disclosed in the present specification; and

FIG. 4 is a process diagram schematically showing an example of a method of manufacturing an electrode sheet disclosed in the present specification.

### DETAILED DESCRIPTION OF EMBODIMENTS

Hereinafter, the self-supporting electrode film and the electrode, and the method of manufacturing the electrode sheet for the self-supporting electrode film will be described with reference to the drawings as appropriate. In the present specification, the self-supporting electrode film and the electrode are, for example, a self-supporting electrode film and a positive electrode constituting a positive electrode of a lithium-ion secondary battery.

### Self-Supporting Electrode Film and Electrode

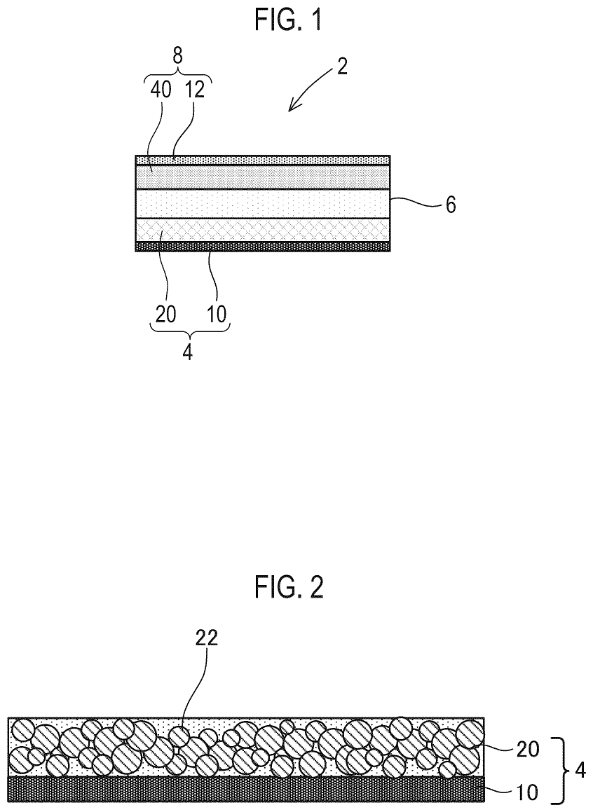

FIG. 1 schematically shows an example of a cell 2 of a lithium-ion secondary battery (hereinafter, simply referred to as a secondary battery). As shown in FIG. 1, the cell 2 as a unit structure of the secondary battery includes a positive electrode 4, a separator 6, and a negative electrode 8. The cell 2 further includes a positive electrode current collector 10 and a negative electrode current collector 12. The secondary battery normally has a structure in which a plurality of cells 2 are laminated. The separator 6 may retain, for example, a liquid or gel electrolyte. The separator 6 is made of a known material such as a polyolefin-based microporous film having fine pores. The separator 6 is impregnated with a liquid electrolyte containing a lithium salt such as lithium hexafluorophosphate, using an organic solvent such as ethylene carbonate (EC), dimethyl carbonate (DMC), diethyl carbonate (DEC), or the like as a medium. Instead of these, a solid electrolyte layer may be used. The negative electrode 8 includes a negative electrode composite layer 40.

FIG. 2 shows an example of a cross-section of the positive electrode 4 of the secondary battery. The positive electrode 4 includes a self-supporting electrode film (hereinafter, simply referred to as an electrode film) 20 and the current collector 10. The current collector 10 is not particularly limited, and examples include an aluminum foil, a nickel foil, and the like.

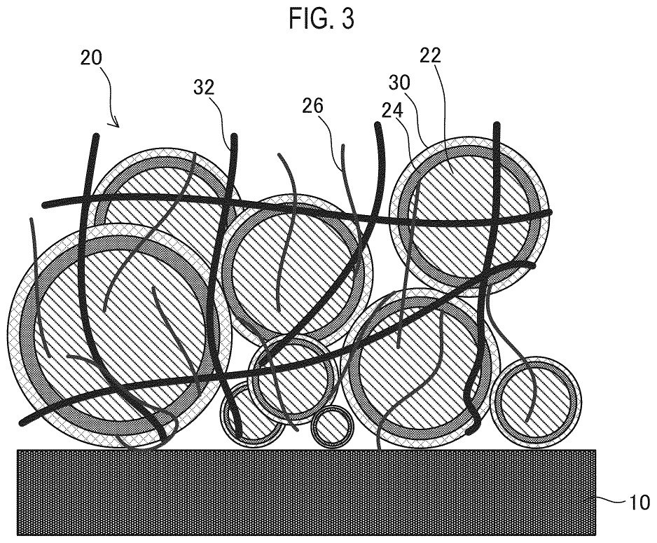

As shown in FIG. 3, the electrode film 20 contains active material particles 22, a conductive additive 26, a first polymer 30, and a second polymer 32.

### Active Material Particles

As the active material particles 22, known positive electrode active material particles can be used. For example, an olivine-type compound or a layered rock salt-type oxide can be used. Examples of the olivine-type compound include lithium iron phosphate (LiFePO₄, LFP), lithium manganese iron phosphate (LiMn_{(1-d)}F_{d}PO₄, LMFP), and lithium manganese phosphate (LiMnPO₄, LMP). As the active material particles 22, one or two or more of these can be used. The active material particles 22 can have any average particle diameter. The active material particles 22 may have a form in which each of the particles is secondarily aggregated.

The active material particles 22 may include an electronically conductive material coating (hereinafter, simply referred to as a coating) 24 that coats at least a portion of a surface of each of the active material particles 22. The coating 24 contributes to improving the electronic conductivity of the active material particles 22. As the electronically conductive material contained in the coating 24, a known material can be used as appropriate. Examples of the electronically conductive material include carbon-based materials such as graphite and semi-graphite, and nanosized metal particle materials.

The coating 24 is provided to cover at least a portion of a surface of each of the active material particles 22. Even when the coating 24 covers the entire surface of each of the active material particles 22, this configuration is acceptable provided that insertion and extraction of lithium ions are possible. The form of the coating 24 is not particularly limited. When the active material particles 22 serve as cores, the coating 24 may be a substantially uniform coating layer, or may be a coating including a carbon-based material of any shape adhered to the surfaces of the active material particles 22. Examples of the former include a carbon-based material coating obtained, for example, by carbonizing an organic material applied to the surfaces of the active material particles 22. Examples of the latter include a coating obtained by causing a carbon-based material to adhere to the surfaces of the active material particles 22 through mechanochemical mixing or the like.

A thickness of the coating 24 is not particularly limited. For example, the thickness may be 0.1 nm or more and 10 nm or less, or 0.5 nm or more and 3 nm or less.

### Conductive Additive

The conductive additive 26 is an additive for improving the electronic conductivity of the electrode film 20. The conductive additive 26 is dispersed and retained in the electrode film 20, but for example, may have a form in which the conductive additive 26 is interposed between the active material particles 22 or is adhered to the surfaces of the active material particles 22 while being dispersed and retained.

The conductive additive 26 is not particularly limited, and various known conductive additives can be used. Examples of the conductive additive 26 include graphite such as natural graphite and artificial graphite; carbon blacks such as acetylene black, Ketjen black, channel black, furnace black, lamp black, and summer black; conductive fibers such as carbon fiber and metal fiber; carbon materials such as graphene and carbon nanotube; fluorinated carbon; metal powders such as aluminum and nickel powders; conductive whiskers such as zinc oxide and potassium titanate; conductive metal oxides such as titanium oxide; and conductive materials such as polyphenylene derivatives. As the carbon nanotube, for example, a single-wall carbon nanotube (SW-CNT) or a multi-wall carbon nanotube (MW-CNT) containing a double-wall carbon nanotube may be preferable. One or two or more of these can be used as the conductive additive 26.

A content of the conductive additive 26 in the electrode film 20 is not particularly limited, but for example, is 0.01% by mass or more and 5% by mass or less with respect to the total mass of the electrode film 20. In addition, for example, the content is 1.0% by mass or more and 3.0% by mass or less, or 1.0% by mass or more and 2.0% by mass or less.

### First Polymer

The first polymer 30 is a polymer having lithium-ion conductivity. As the first polymer 30, the material is not particularly limited; examples include polyethylene oxide (PEO), polypropylene oxide, polyacrylonitrile, polyvinyl chloride, polymethyl methacrylate, polyvinylidene fluoride, ethylene carbonate, polyethylene, polypropylene, polystyrene, ABS resin, polyacrylate, polymethacrylate, polyvinyl alcohol, and polycarbonate. One kind or two or more of these can be used. The first polymer 30 functions as a binder in the electrode film 20.

Here, each of the polymers contains, for example, a homopolymer and a copolymer including a basic structural unit based on the name of the polymer and a structural unit in which the basic structural unit is modified. For example, the PEO contains a homopolymer and a copolymer containing either or both of a structural unit derived from ethylene oxide and a modified structural unit thereof, and can have various forms such as linear, comb-shaped, or crosslinked. Such polymers are known to those skilled in the art, and can be obtained or manufactured by those skilled in the art as appropriate.

For example, as the first polymer 30, PEO such as a homopolymer of a structural unit derived from ethylene oxide having a number-average molecular weight of 3,000 or more and 10,000,000 or less can be used. The number-average molecular weight of such PEO is also, for example, 3,000 or more and 50,000 or less, 8,000 or more and 50,000 or less, or 10,000 or more and 30,000 or less.

The first polymer 30 may be one or two or more selected from the group including PEO, polyacrylonitrile, polyvinyl chloride, polymethyl methacrylate, and polyvinylidene fluoride. These polymers have lithium-ion conductivity and can suppress a reduction in lithium-ion conductivity.

As the first polymer 30, PEO may be preferably used. The PEO may have a degree of crystallinity of 50% or less. The degree of crystallinity may be, for example, 40% or less, 30% or less, or 20% or less, in which case the lithium-ion diffusion resistance can be further reduced. The degree of crystallinity may be, for example, 5% or more, 10% or more, 20% or more, or 30% or more. The range of the degree of crystallinity may be, for example, 10% or more and 50% or less, 20% or more and 50% or less, 10% or more and 30% or less, or 10% or more and 20% or less. In this range, the lithium-ion diffusion resistance can be reliably reduced.

The degree of crystallinity of the polymer can be acquired by measurement using Raman spectroscopy and XRD.

The first polymer 30 may be contained in the electrode film 20 in a form covering either or both of the active material particles 22 and the coating 24. The first polymer 30 can cover a portion or the entirety of the coating 24 within a range in which the function of the coating 24 is not impaired.

The first polymer 30, having a form that covers either or both of the active material particles 22 and the coating 24, may suppress, in the electrode film 20, damage to the coating 24 as well as damage to the active material particles 22. With the first polymer 30 being contained in such a form, a reduction in powder resistance of the electrode film 20 is suppressed.

The first polymer 30 is a polymer that does not fibrillate. In addition, the first polymer 30 may preferably have a melting point of 60° C. or higher and 260° C. or lower. With a melting point within such a temperature range, the first polymer 30 is easily rendered flowable and mixed with the active material particles 22 and the like.

The melting point of the first polymer 30 is, for example, 70° C. or higher, 75° C. or higher, 80° C. or higher, or 90° C. or higher, and also 240° C. or lower, 230° C. or lower, 220° C. or lower, or 200° C. or lower. The range of the melting point of the first polymer 30 can, in addition to the above range, be set by appropriately combining the lower limit temperature and the upper limit temperature described above. For example, the melting point is 60° C. or higher and 240° C. or lower, 60° C. or higher and 200° C. or lower, 60° C. or higher and 180° C. or lower, or 60° C. or higher and 120° C. or lower.

A content of the first polymer 30 in the electrode film 20 is not particularly limited, and may be a content at which the damage to the coating 24 can be suppressed. For example, when the content of the first polymer 30 is 0.1% by mass or more and 3.0% by mass or less with respect to the total mass of the electrode film 20, the frictional force during fabrication of the electrode film 20 can be reduced, the coating 24 can be protected, so that a reduction in the powder resistance of the electrode film 20 may be effectively suppressed. In addition, for example, the content is 0.5% by mass or more, 0.7% by mass or more, 0.8% by mass or more, 1.0% by mass or more, 1.5% by mass or more, or 2.0% by mass or more. In addition, the content is 2.5% by mass or less, 2.0% by mass or less, 1.5% by mass or less, or 1.2% by mass or less. The range of the content of the first polymer 30 can, in addition to the above range, be set by appropriately combining the lower limits and the upper limits of these. For example, the content is 0.7% by mass or more and 3.0% by mass or less, 0.8% by mass or more and 2.0% by mass or less, 0.8% by mass or more and 1.5% by mass or less, or 0.8% by mass or more and 1.2% by mass or less.

### Second Polymer

The electrode film 20 contains the second polymer 32. In the electrode film 20, the second polymer 32 has a fibrillated state. For example, the second polymer 32, in a fibrillated state, is present on the outside of the active material particles 22, which may be coated with the coating 24, to entangle the active material particles 22 in a fibrous form.

As the second polymer 32, a polymer that is fibrillable is used. When a shear force is applied to the second polymer 32, the second polymer 32 fibrillates. The second polymer 32, in a fibrillated state, entangles the active material particles 22 and the conductive additive 26, constraining them and imparting mechanical strength to the electrode film 20.

The second polymer 32 can be used without particular limitation as long as the second polymer 32 is a polymer that is fibrillable. The polymer that is fibrillable is well known to those skilled in the art. Examples of the second polymer 32 include polytetrafluoroethylene (PTFE), polyolefin, polyalkylene, polyether, styrene-butadiene, polysiloxane, a copolymer of polysiloxane, branched polyether, polyvinyl ether, and copolymers thereof. Examples of the second polymer 32 also contain cellulose containing carboxyalkyl cellulose such as carboxymethyl cellulose (CMC). As the second polymer 32, one or two or more of these can be used. For example, the second polymer 32 may preferably be PTFE. This is because the PTFE has excellent fibrillatability and binder performance.

The second polymer 32 is a polymer that is preferably fibrillable at a temperature of 60° C. or higher and 260° C. or lower. The temperature range coincides with the preferred melting-point temperature range of the first polymer 30. When the second polymer 32 is fibrillable within a range in which the first polymer 30 to be used becomes flowable, a lubricating effect of the first polymer 30 may be expected during the composite formation of the active material particles 22 and the like with the second polymer 32. The second polymer 32 preferably has heat resistance at a temperature at which the first polymer 30 becomes flowable. From this viewpoint, the second polymer 32, for example, preferably has a melting point of higher than 260° C.

A content of the second polymer 32 in the electrode film 20 is not particularly limited, and may be a content at which the electrode film 20 can be constrained and integrated. The content of the second polymer 32 is, for example, 1.0% by mass or more and 10% by mass or less with respect to the total mass of the electrode film 20. In addition, for example, the content is 1.5% by mass or more, 2.0% by mass or more, 2.5% by mass or more, or 3.0% by mass or more. In addition, the content is 8.0% by mass or less, 6.0% by mass or less, or 5.0% by mass or less. The range of the content of the second polymer 32 can, in addition to the above range, be set by appropriately combining the lower limits and the upper limits of these. For example, the content is 1.5% by mass or more and 5.0% by mass or less, 2.0% by mass or more and 5.0% by mass or less, or 2.5% by mass or more and 4.5% by mass or less.

The electrode film 20 may contain, in addition, a polymer that functions as a binder as necessary. Such a polymer can be, for example, a known polymer that can be used for this type of electrode, in addition to the first polymer 30 and the second polymer 32 described above. These polymers may be in a particulate form or the like.

The electrode film 20 described above has, for example, a thickness of about 10 μm or more and 500 μm or less, and constitutes the positive electrode 4 together with the current collector 10.

According to the positive electrode 4, since the electrode film 20 contains the first polymer having excellent lithium-ion conductivity, the lithium-ion diffusibility in the secondary battery using the electrode film 20 is excellent. In addition, the integrality of the electrode film 20 is also improved by the binder function of the first polymer 30. In addition, since the first polymer 30 is interposed on the surfaces of the active material particles 22, the lithium-ion conductivity can be effectively exhibited. In addition, the damage to the active material particles 22 is suppressed.

In addition, in the electrode film 20, the second polymer 32 is dispersed generally uniformly among the active material particles 22 and the conductive additive 26. Further, the active material particles 22 can be constrained to be entangled in a fibrous form on the outside. From this point, an increase in powder resistance is suppressed.

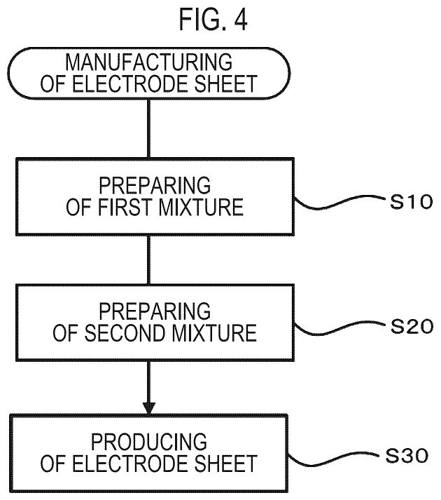

Next, a method of manufacturing an electrode sheet for manufacturing such an electrode film 20 will be described with reference to FIG. 4 as appropriate. The electrode sheet is laminated onto the current collector 10 and, as appropriate, integrated by hot pressing or the like to constitute the electrode film 20. FIG. 4 shows an example of a method of manufacturing the electrode sheet.

The method of manufacturing includes a step S10 of preparing a first mixture, a step S20 of preparing a second mixture using the first mixture, and a step S30 of producing an electrode sheet for the electrode film 20 using the second mixture.

### Step S10 of Preparing First Mixture

Step S10 includes preparing the first mixture by mixing the active material particles 22, the conductive additive 26, and the first polymer 30 that does not fibrillate. The first mixture preferably does not contain the second polymer 32 that is fibrillable. As a result of including the second polymer 32, the protection of the coating 24 by the first polymer 30 and the overall lubricity during mixing may be reduced.

The first mixture may be a mixture containing the active material particles 22, the conductive additive 26, and the first polymer 30, and having a form in which at least the first polymer 30 covers the surfaces of the active material particles 22 (or, the coatings 24, when the coatings 24 are present). In step S10, the first mixture can be obtained by mixing the materials to be mixed with the first polymer 30 in a flowable state. For example, when using a polymer having a melting point within a temperature range of 60° C. or higher and 260° C. or lower as the first polymer 30, a suitable first mixture can be obtained by mixing the materials to be mixed under an appropriate shear force at a temperature of 60° C. or higher and 260° C. or lower at which the polymer melts and becomes flowable.

When the first polymer 30 melts and becomes flowable, the frictional force between the active material particles 22 is reduced. As a result, the first polymer 30 is uniformly dispersed among the active material particles 22 and the conductive additive 26, and adheres to the surfaces of the active material particles 22. By using the first polymer 30 rendered flowable, the first polymer 30 functions as a lubricant during the mixing of the active material particles 22 and the conductive additive 26, thereby facilitating the mixing without the use of a solvent. As a result, the damage to the active material particles 22 or the coating 24 during the mixing with the conductive additive 26 may be suppressed.

Step S10 may include a plurality of stages as long as the first mixture is obtained. For example, the active material particles 22 and the first polymer 30 may be mixed in advance with the first polymer 30 in a flowable state to obtain a form in which the surface of the coating 24 is covered with the first polymer 30, and then the conductive additive 26 may be added and mixed while maintaining the first polymer 30 in the flowable state. In this way, when the coating 24 is present, the application of a strong frictional force to the coating 24 can be effectively suppressed.

In preparing the first mixture, the conductive additive 26 and the first polymer 30 can be used within the range of the content described above with respect to the total mass of the second mixture to be finally obtained. The amount of the active material particles 22 may be set to constitute the remainder of the total mass of the second mixture, excluding the conductive additive 26, the first polymer 30, and the second polymer 32.

Step S10 can be performed using a known mixing device. Examples of the mixing device include a known mixing device usable for shear mixing, including various kneaders, such as a pressure kneader, provided with rotating bodies such as a roll, a rotor, a paddle, a blade, a gear, a screw; a Banbury mixer; a Henschel mixer; a twin-screw extruder; and various mills including a jet mill, a roller mill, a hammer mill, and the like. Those skilled in the art can appropriately set mixing conditions such as a shear force and a mixing time, to obtain a suitable mixed state of the active material particles 22 and the conductive additive 26.

### Step S20 of Preparing Second Mixture

Step S20 includes preparing a second mixture containing the second polymer 32 in a fibrillated state by mixing the first mixture with the second polymer 32 that is fibrillable.

The second mixture is a mixture that, in addition to the active material particles 22, the conductive additive 26, and the first polymer 30 derived from the first mixture, contains the second polymer 32 in a fibrillated state. The second mixture can be obtained by mixing these materials to be mixed so as to fibrillate the second polymer 32.

After preparing the first mixture, the second mixture having a structure in the electrode film 20 or a structure approximating the structure can be obtained by adding the second polymer 32 and mixing the second polymer 32 to be fibrillable. That is, in the second mixture, the first polymer 30 has a form that covers the coatings 24 of the active material particles 22, and the second polymer 32 has a fibrillated state. Furthermore, the second polymer 32 constrains the active material particles 22 by entangling the active material particles 22 in a fibrous form on the outside.

Step S20 is preferably performed, as in step S10, with the first polymer 30 in a melted and flowable state. That is, the mixing is preferably performed at a temperature of 60° C. or higher and 260° C. or lower, based on the melting point of the first polymer 30. In this way, in step S20 as well, the first polymer 30 can function as a lubricant, the mixing in step S20 can be facilitated, and the damage to the coating 24 can be suppressed.

In preparing the second mixture, the second polymer can be used within the range of the content described above with respect to the total mass of the second mixture to be finally obtained.

Step S20 can be performed, as in step S10, using a known mixing device. Those skilled in the art can appropriately set mixing conditions such as a shear force and a mixing time to obtain the fibrillation of the second polymer 32 and a suitable mixed state of the materials to be mixed.

### Step S30 of Producing Electrode Sheet for Electrode Film

Step S30 includes producing an electrode sheet for producing the electrode film 20 using the second mixture. Here, the thickness of the electrode sheet is about 10 μm or more and 2,000 μm or less, or 10 μm or more and 1,000 μm or less. The sheet-forming process is not particularly limited. For example, calendering may be employed, in which, without using a support, the second mixture is fed between rotating rollers and calendered to a sheet while being hot-pressed. Alternatively, a pressing process may be employed in which the electrode composite mixture is supplied to a suitable mold and hot-pressed.

The obtained electrode sheet includes the active material particles 22, the conductive additive 26, the first polymer 30, and the second polymer 32 in the same form as in the electrode film 20 described above, and has a predetermined mechanical strength. Therefore, after that, the electrode film 20 that can be self-supporting on its own without a support can be produced.

Further, the positive electrode 4 and the secondary battery can also be produced using such an electrode sheet. First, the current collector 10 and the electrode sheet are laminated. Further, the electrode sheet is densified by applying pressure at a predetermined temperature to obtain the electrode film 20 having a thickness of about 10 μm or more and 500 μm or less. At the same time as obtaining the electrode film 20, the positive electrode 4 in which the electrode film 20 is integrated with the current collector 10 can be obtained. Further, the secondary battery can be obtained by integrating the separator 6, the negative electrode composite layer 40, and the negative electrode current collector 12 with the positive electrode 4. The secondary battery can be produced by a known method as appropriate.

In the electrode film 20 obtained in this way, lithium-ion conductivity is imparted by the first polymer 30, so that the electrode film 20 has excellent integrality without reducing the lithium-ion diffusibility. Therefore, by using the electrode film 20, the positive electrode 4 and the secondary battery including the positive electrode 4, which can exhibit good electrode characteristics, can be obtained.

In the above description, the electrode film 20 and the like has been described, but according to the present specification, in addition to the electrode sheet as a precursor of the electrode film 20, the positive electrode 4 including the electrode film 20, and the secondary battery including the positive electrode 4 are also provided. In addition, in the above description, the method of manufacturing the electrode sheet for the electrode film 20 has been described, but according to the present specification, a method of manufacturing a mixture for an electrode film is also provided, the method including preparing a first mixture, and preparing a second mixture. In addition to the steps in the method of manufacturing the electrode sheet, a method of manufacturing an electrode (positive electrode 4), is also provided, the method including producing the electrode film 20 using the electrode sheet. In addition to the method of manufacturing the electrode, a method of manufacturing a secondary battery is also provided, the method including producing the secondary battery.

Hereinafter, Examples in which the disclosure of the present specification is embodied will be described, but the Examples are for illustrative purposes only and are not intended to limit the scope of the disclosure of the present specification.

In the present Example, a mixture for an electrode film of a positive electrode of a lithium-ion secondary battery was prepared by the following method, an electrode sheet was produced, and the powder resistance thereof was measured.

For the preparation of the mixture, as the olivine-type compound particles having a carbon coating, lithium iron phosphate (LFP), as the conductive additive, MW-CNT, as the first polymer, PEO1 (degree of crystallinity: 20%, melting point: about 60° C.) and PEO2 (degree of crystallinity: 50%, melting point: about 60° C.), and as the second polymer, PTFE were used.

### Example 1

With respect to the mixture for the electrode film in Example 1, a first mixture for the electrode film, containing active material particles, a conductive additive, and a first polymer, but not containing a second polymer, was prepared. Thereafter, a second mixture as the mixture for an electrode film, containing the second polymer, was further prepared. The mass ratio of each material in the second mixture was set to 94.1/1.5/1.0/3.4 for the active material particles/conductive additive/PEO1/PTFE.

First, the active material particles (LFP), the conductive additive (MW-CNT), and the first polymer (PEO) were compounded at the above-described mass ratio, and mixed using a kneader under the mixing conditions of 80° C., 60 rpm, and 600 seconds to obtain a first mixture.

Next, the second polymer (PTFE) was compounded into the first mixture such that the mass ratio was satisfied, and mixed using the kneader under the mixing conditions of 160° C., 60 rpm, and 30 seconds to obtain a second mixture as the mixture for an electrode film.

The second mixture was further calendered using a calendering device at 160° C., with a roll gap clearance of 340 μm, a roll 1 speed of 1.8 m/sec, and a roll 2 speed of 2.4 m/se, to obtain an electrode sheet. For a sample prepared from this electrode sheet by a predetermined method, the lithium-ion diffusion resistance was acquired by measuring impedance in accordance with conventional procedures. The results are shown in Table 1.

### Example 2

Except that PEO2 was used as the first polymer in the first mixture in place of PEO1, the procedures were the same as in Example 1, and the lithium-ion diffusion resistance was acquired.

### Comparative Example 1

As Comparative Example 1, the first polymer (PEO) was not used in the first mixture, and instead, the mass ratio of the active material particles was increased in place of the first polymer. Except for this, the mixing was performed under the same mixing conditions as in Example 1 to obtain the first mixture, the second mixture, and the electrode sheet of Comparative Example 1, and the lithium-ion diffusion resistance was measured in the same manner as in Example 1. In Comparative Example 1, the mass ratio of each material in the second mixture (active material particles/conductive additive/PTFE) was 95.1/1.5/3.4. The results are shown in Table 1.

TABLE 1

| | Composition of the Positive Electrode Composite | | | | | |
|---|---|---|---|---|---|---|
| | | MW- | | Binder | | Impedance |
| | LFP | CNT | PEO | PTFE | a degree of | (Li-ion |
| | Content | Content | Content | Content | crystallinity | Diffusion |
| | % by | % by | % by | % by | of PEO | Resistance) |
| Type | mass | mass | mass | mass | % | Ω |
| Example 1 | 94.1 | 1.5 | PEO1.1.0 | 3.4 | 20 | 0.24 |
| Example 2 | 94.1 | 1.5 | PEO2.1.0 | 3.4 | 50 | 0.30 |
| Comparative | 95.1 | 1.5 | 0.0 | 3.4 | — | 0.32 |
| Example 1 | | | | | | |

As shown in Table 1, Example 1 using PEO1 having a degree of crystallinity of 20% exhibited the lowest lithium-ion diffusion resistance, and Example 2 using PEO2 having a degree of crystallinity of 50% also exhibited low lithium-ion diffusion resistance. In contrast, Comparative Example 1, in which PEO was not used, exhibited the highest lithium-ion diffusion resistance.

From the above, it was found that using a polymer having lithium-ion conductivity, and further using PEO having a degree of crystallinity of 20% or more and 50% or less, are effective in suppressing the lithium-ion diffusion resistance in the electrode sheet.

In addition, in Example 1, a cross-section of the obtained electrode sheet was observed using a transmission electron microscope, revealing that PEO1, as the first polymer, was interposed on the surfaces of the active material particles to cover a portion of a surface of each of the active material particles and was present as a composite with the active material particles within the electrode film. In addition, PTFE, as the second polymer, was dispersed generally uniformly among the active material particles having a carbon coat and the conductive additive as the CNT. Further, PTFE constrained the active material particles by entangling the active material particles in a fibrous form on the outside.

From the above, a first mixture was prepared by preliminarily mixing the active material particles and the conductive additive, using a first polymer having lithium-ion conductivity, such as PEO that is meltable and capable of becoming flowable. Further, it was found that, thereafter, preparing a second mixture by adding a second polymer that is fibrillable such as PTFE, and using this second mixture as the mixture for the electrode film, contributes to improving the lithium-ion conductivity of the electrode sheet. That is, this method of manufacturing makes it possible to acquire a composite form in which the lithium-ion conductivity of PEO can be effectively exhibited. As a result, it was found that a self-supporting electrode film can be effectively produced without increasing the binder content and, moreover, that the lithium-ion diffusivity in the electrode sheet can be improved.

Furthermore, it was found that setting the degree of crystallinity of the first polymer having lithium-ion conductivity to be used to a predetermined range, for example, 50% or less in the case of PEO, reduces the lithium-ion diffusion resistance. In particular, it was found that PEO is more effective when the degree of crystallinity of PEO is 20% or less.

The technical elements described in the present specification or the drawings exhibit technical usefulness alone or in various combinations and are not limited to the combinations described in the claims at the time of filing.

What is claimed is:

1. A self-supporting electrode film comprising:
positive electrode active material particles;
a conductive additive;
a first polymer having lithium-ion conductivity; and
a second polymer having a fibrillated state.

2. The self-supporting electrode film according to claim 1, wherein the first polymer is polyethylene oxide having a degree of crystallinity of 10% or more and 50% or less.

3. The self-supporting electrode film according to claim 2, wherein a portion of a surface of each of the positive electrode active material particles is coated with the first polymer.

4. The self-supporting electrode film according to claim 3, wherein the second polymer contains polytetrafluoroethylene.

5. An electrode comprising the self-supporting electrode film according to claim 1.

6. A secondary battery comprising the electrode according to claim 5.

7. A method of manufacturing an electrode sheet for a self-supporting electrode film, the method comprising:
preparing a first mixture by mixing positive electrode active material particles, a conductive additive, and a first polymer that has lithium-ion conductivity and does not fibrillate, with the first polymer in a flowable state;
preparing a second mixture by mixing the first mixture with a second polymer that is fibrillable, the second mixture containing the second polymer in a fibrillated state; and
producing the electrode sheet by using the second mixture.

8. The method according to claim 7, wherein the first polymer includes polyethylene oxide having a degree of crystallinity of 10% or more and 50% or less.

9. A method of manufacturing an electrode including a self-supporting electrode film, the method comprising:
preparing a first mixture by mixing positive electrode active material particles, a conductive additive, and a first polymer that does not fibrillate, with the first polymer in a flowable state;
preparing a second mixture by mixing the first mixture with a second polymer that is fibrillable, the second mixture containing the second polymer in a fibrillated state;
producing an electrode sheet for the self-supporting electrode film by using the second mixture; and
producing the electrode including the self-supporting electrode film by joining the electrode sheet to a current collector.
